(19) United States
(12) Patent Application Publication
(10) Pub. No.: US 2005/0249224 A1
(43) Pub. Date: Nov. 10, 2005

(54) Method for making contact between a peer communication terminal and an index server

(75) Inventors: Frank-Uwe Andersen, Berlin (DE); Hermann De Meer, Passau (DE); Ivan Dedinksi, Passau (DE); Tobias Hossfeld, Wurzburg (DE); Cornelia Kappler, Berlin (DE); Andreas Maeder, Wurzburg (DE); Jens Oliver Oberender, Passau (DE); Phuoc Tran-Gia, Wurzburg (DE); Kurt Tutschku, Gerbrunn (DE)

Correspondence Address: MORRISON & FOERSTER LLP, 1650 TYSONS BOULEVARD, SUITE 300, MCLEAN, VA, 22102, US

(73) Assignee: Siemens Aktiengesellschaft, Munchen (DE)

(21) Appl. No.: 11/117,700

(22) Filed: Apr. 29, 2005

(30) Foreign Application Priority Data
Apr. 30, 2004 (DE) 10 2004 023 651.8

(51) Int. Cl. H04L 12/56

(52) U.S. Cl. 370/401; 370/395.2

(57) ABSTRACT

A method for making contact between a peer communication terminal and an index server for providing peer-to-peer data transmission is provided. The method involves a peer communication terminal associated with a first telecommunication network sending a make-contact message addressed to a first index server. This make-contact message is transmitted to a proxy node in the first telecommunication network. The proxy node terminates the transmission of the make-contact message, and the proxy node then prompts contact to be made between the peer communication terminal and a second index server, which is arranged in the first telecommunication network.

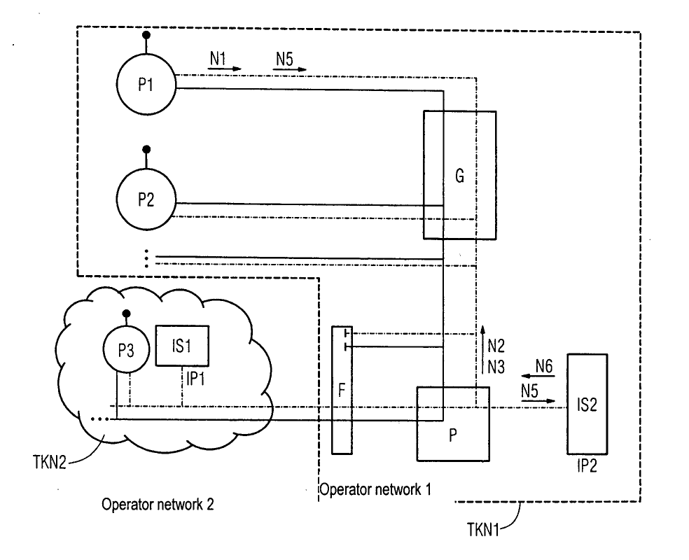

### CLAIM FOR PRIORITY

This application claims priority to German Application No. 10 2004 023 651.8, filed Apr. 30, 2004, which is incorporated herein, in its entirety, by reference.

### TECHNICAL FIELD OF THE INVENTION

The invention relates to a method for making contact between a peer communication terminal and an index server for providing peer-to-peer data transmission.

### BACKGROUND OF THE INVENTION

Peer-to-peer data transmissions, in which peer communication terminals (often simply called “peers”) are connected to one another via a telecommunication network, are generally known. The peer communication terminals can each perform the functions of either server or client during peer-to-peer data transmission. By way of example, a peer communication terminal can provide files (e.g. music files) for other peer communication terminals and can also retrieve them therefrom. The peer communication terminals can thus provide services for other peer communication terminals and can also retrieve services from other peer communication terminals. In this context, the peer communication terminals have equal authority among one another. The peer-to-peer data transmission between peer communication terminals differs from the data transmission between client and server computers in client/server communication networks. In the case of client/server data transmission, a communication terminal operates either as a server (which provides a service for another communication terminal) or as a client (which retrieves a service from a server). In the case of peer-to-peer data transmission, data are held locally in various peer communication terminals and are transmitted therebetween.

Peer-to-peer data transmissions today give rise to a considerable proportion of the data transmission volume which arises in telecommunication networks. It is estimated that between 50 and 80% of the data volume transmitted via the Internet comes from peer-to-peer data transmissions.

Special network nodes (“index servers”) store information about which peer communication terminals hold particular data or files. When a peer communication terminal wishes to obtain a file, for example, this peer communication terminal asks the index server for the address of a further peer communication terminal, on which the desired file is held. The peer communication terminal then retrieves the file directly from the further peer communication terminal.

To use index server services, a peer communication terminal needs to contact such an index server. In this case, the peer communication terminal contacts an index server whose address is known by the peer communication terminal (for example because it has been input by a user of the peer communication terminal or is stored in the peer communication terminal from earlier data transmissions). An operator of a telecommunication network cannot predict that index server with which a peer communication terminal will make contact.

### SUMMARY OF THE INVENTION

The invention is directed to a method which can be used to influence the contact made with index servers in a specific fashion.

According to an aspect of the invention, a method is provided for making contact between a peer communication terminal and an index server for providing peer-to-peer data transmission. The method includes a peer communication terminal associated with a first telecommunication network sending a make-contact message addressed to a first index server. This make-contact message is transmitted to a proxy node in the first telecommunication network. The proxy node terminate the transmission of the make-contact message. The proxy node then prompts contact to be made between the peer communication terminal and a second index server, which is arranged in the first telecommunication network.

In this context, it is particularly advantageous that the peer communication terminal does not make contact with the first index server, to which the make-contact message was originally sent, but rather that contact is made with the second index server, the choice of the second index server being influenced by the proxy node. A telecommunication network operator in the first telecommunication network can thus configure the proxy node in suitable fashion in order to prompt the peer communication terminals in the first telecommunication network to make contact with the second index server, arranged in the first telecommunication network. This advantageously makes it possible to achieve a situation in which the second index server in the first telecommunication network is used and the use of other index servers is prevented.

According to another aspect of the invention, the peer communication terminal may send the make-contact message to a first index server in a second telecommunication network. Then, preferably, the proxy-node identifies that the first index server is arranged outside of the first telecommunication network, and the proxy node then terminates the transmission of the make-contact message. This advantageously achieves a situation in which the peer communication terminals in the first telecommunication network make contact with the second index server, arranged in the first telecommunication network. The use of index servers which, like the first index server, are arranged outside of the first telecommunication network (that is to say the use of index servers from “foreign” telecommunication networks) is prevented.

According to another aspect of the invention, the proxy node preferably uses the address of the first index server to identify that the first index server is arranged outside of the first telecommunication network. By evaluating the address to which the make-contact message has been sent, it is possible to identify whether the first index server is arranged inside or outside of the first telecommunication network very easily and quickly.

According to another aspect of the invention, the proxy node preferably prompts the contact to be made between the peer communication terminal and the second index server by virtue of the proxy node simulating a response message from the first index server when the make-contact message is received. Then, the proxy node preferably uses the response message to send an address for the second index server to the peer communication terminal, whereupon the peer communication terminal makes contact with the second index server. The peer communication terminal advantageously does not need to be configured in a special manner in order to be involved in the inventive method; the necessary configuration work is essentially limited to setting up the proxy node.

According to another aspect of the invention, the peer communication terminal may send a second make-contact message, which is addressed to the second index server, following the response message. This second make-contact message is preferably transmitted to the proxy node. The proxy node then preferably forwards the second make-contact message to the second index server, as a result of which the contact is made between the peer communication terminal and the second index server. The second make-contact message is forwarded to the second index server by the proxy node unchanged, since the second index server is arranged in the first telecommunication network.

### BRIEF DESCRIPTION OF THE DRAWINGS

To provide a further explanation of the invention, the figure is used to explain an exemplary embodiment of the inventive method.

### DETAILED DESCRIPTION OF THE INVENTION

The figure shows a first mobile peer communication terminal P1 (mobile peer) and a second mobile peer communication terminal P2. The mobile peer communication terminals P1 and P2 may be mobile telephones or computers or personal digital assistants (PDAs) with a mobile radio interface, for example. The mobile peer communication terminals P1 and P2 are associated with a first telecommunication network TKN1, which is a mobile radio network in the exemplary embodiment. From the first telecommunication network TKN1, the figure shows only a gateway G (in the form of a Gateway GPRS Support Node, GGSN), a proxy node P (Peer-to-Peer Proxy, P2P Proxy), a second index server IS2 and a firewall F. Further elements of the mobile radio network TKN1, such as base stations and switching centers, have been omitted in the figure for the sake of clarity. The second index server IS2 has an associated address in the form of a second Internet address IP2.

The first telecommunication network TKN1 is under the control of a first telecommunication network operator; the first telecommunication network TKN1 is thus a first operator network (operator network 1, first operator domain). The network operator of the first telecommunication network can transmit data within the first telecommunication network at the cost-of-sale price, i.e. the network operator of the first telecommunication network does not need to make payments to other network operators for such transmission of data.

The bottom left-hand part of the figure schematically shows a second telecommunication network TKN2 in the form of a peer-to-peer landline network (P2P landline network, fixed P2P network). Installed in this second telecommunication network are a stationary peer communication terminal P3 (fixed-location peer communication terminal, fixed peer) and also further stationary peer communication terminals (not shown). The stationary peer communication terminal P3 is a computer connected to the second telecommunication network TKN2 by a data line, for example. The second telecommunication network TKN2 contains a first index server IS1, which has an associated address in the form of a first Internet address Ip1. The second telecommunication network TKN2 may be the Internet, for example.

The second telecommunication network TKN2 is a second operator network (operator network 2) belonging to a second network operator; the second telecommunication network is thus under the control of the second network operator. The second network operator can transmit data within the second operator network at the cost-of-sale price, i.e. the second network operator does not need to make payments to another network operator for such transmission of data.

The mobile peer communication terminals P1 and P2 are connected to one another via the gateway G. The user data interchange (file exchange) between the two mobile peer communication terminals P1 and P2 and the stationary peer communication terminal P3 is symbolized in the figure by means of a solid line. Signaling messages are exchanged between the peer communication terminals, the gateway, the first index server IS1, the second index server IS2 and the proxy node. The data transmission channel for these signaling messages is symbolized in the figure by means of a dash-dot line.

The text below describes an exemplary embodiment of the inventive method. The first peer communication terminal P1 needs to participate in a peer-to-peer data transmission. By way of example, the peer communication terminal P1 needs to download a file from a file-providing peer communication terminal (file download) or the first peer communication terminal P1 needs to provide a file for other peer communication terminals for download (file upload). To participate in the peer-to-peer data transmission method, the first peer communication terminal P1 needs to make contact with an index server. The peer communication terminal P1 knows the address IP1 of the first index server IS1, since this address IP1 has been input into the peer communication terminal by a user thereof, for example. The peer communication terminal P1 then sends a make-contact message N1 which is addressed to the first index server IS1. This make-contact message is provided with the address IP1 of the first index server IS1. If the peer communication terminal P1 is an “E-Donkey” peer (or a peer communication terminal running an application based on the E-Donkey protocol), the make-contact message used can be a “connect” message configured on the basis of E-Donkey stipulations.

The make-contact message N1 is transmitted to the proxy node P via the gateway G. (Direct transmission of the make-contact message N1 to the index server IS1 bypassing the proxy node P is not possible, since such transmission would be prevented by the firewall) F. The proxy node P receives the make-contact message N1 and identifies from the address IP1 which is also transmitted with the make-contact message N1 that the make-contact message has been sent to an index server which is arranged outside of the first telecommunication network TKN1 (namely in the second telecommunication network TKN2). For this reason, the proxy node P terminates the transmission of the make-contact message N1. The proxy node P then simulates the behavior of the first index server IS1. The proxy node P simulates those response messages N2 and N3 from the first index server IS1 which the first index server IS1 would produce upon receiving the make-contact message N1.

By way of example, the proxy node P can simulate the message “login success” as response message N2 and can simulate the message “visible servers” from the E-Donkey protocol as response message N3. The proxy node P uses the response message N3 (“visible servers”) to send the address IP2 of the second index server IS2 to the peer communication terminal P1. This prompts the peer communication terminal P1 to make contact with the second index server IS2.

The contact is made with the second index server IS2 by virtue of the peer communication terminal P2 producing a second make-contact message N5 upon receipt of the response message N3, providing said make-contact message N5 with the address IP2 of the second index server IS2 and sending the second make-contact message N5 to the second index server IS2. This second make-contact message N5 is transmitted to the proxy node P via the gateway G. From the second address IP2, the proxy node P identifies that the second index server IS2 is arranged within the first telecommunication network TKN1, and it therefore transmits the second make-contact message N5 to the second index server IS2 unchanged. To confirm receipt of the second make-contact message N5, the second index server IS2 transmits a response message N6 to the peer communication terminal P1. This response message N6 may be the E-Donkey response message “login success”, for example. Contact has thus been made between the peer communication terminal P1 and the second index server IS2 in the first telecommunication network TKN1.

In a further exemplary embodiment, the inventive method may also proceed in a manner such that the first index server IS1 and the second index server IS2 are located in the same telecommunication network (e.g. in the first telecommunication network TKN1). The proxy node P can reroute the contact-making from the first index server IS1 to the second index server IS2 (e.g. to achieve an even distribution of load).

The contact-making between the peer communication terminal and the index server may serve various purposes: the peer communication terminal P1 may wish to register with the index server, for example (to be able to use it more often in future), and may therefore wish to send a registration message to the index server. However, the peer communication terminal P1 may also wish to send a search message relating to a particular file to the index server, for example, in order to obtain addresses for peer communication terminals providing this file from the index server.

The method described has a series of advantages: for the peer communication terminals associated with the first telecommunication network TKN1, these peer communication terminals now make contact with the second index server IS2 in the first telecommunication network TKN1 and not with the index server IS1 (e.g. which is arranged outside of the first telecommunication network TKN1). This keeps data transmission traffic in the “personal” network (operator network 1) of the telecommunication network operator of the telecommunication network TKN1. This has the advantage that no compensation payments need to be paid (for example to the operator of the telecommunication network TKN2). It is also possible to perform further peer-to-peer data transmissions, which may follow registration of the peer communication terminal P1, within the limits of the first telecommunication network TKN1. The contact is made with the second index server IS2 regardless of whether or not an address for the second index server IS2 is known by the peer communication terminal P1 at the start of the contact-making method. Contact is always made with the second index server IS2. For the network operator of the telecommunication network TKN1, it is also advantageous that he is able to plan the loading of the second index server IS2 better, since, by way of example, all peer communication terminals in the telecommunication network TKN1 register with the second index server IS2 and use it to perform peer-to-peer data transmissions. Regardless of whether the index servers involved are in the same telecommunication network or in different telecommunication networks, the proxy node can distribute the make-contact requests to selected index servers.

1. A method for making contact between a peer communication terminal and an index server for providing peer-to-peer data transmission, comprising:
sending a make-contact message addressed to a first index server from a peer communication terminal associated with a first telecommunication network;
transmitting the make-contact message to a proxy node in the first telecommunication network;
terminating, by the proxy node, the transmission of the make-contact message; and
prompting contact, by the proxy node, to be made between the peer communication terminal and a second index server, which is arranged in the first telecommunication network.

2. The method as claimed in claim 1, wherein
the peer communication terminal sends the make-contact message to a first index server in a second telecommunication network,
the proxy node identifies that the first index server is arranged outside of the first telecommunication network, and
the proxy node then terminates the transmission of the make-contact message.

3. The method as claimed in claim 1, wherein the proxy node uses an address for the first index server to identify that the first index server is arranged outside of the first telecommunication network.

4. The method as claimed in claim 1, wherein
the proxy node prompts contact to be made between the peer communication terminal and the second index server by virtue of the proxy node simulating a response message from the first index server when the make-contact message is received, and
the proxy node uses the response message to send an address for the second index server to the peer communication terminal, whereupon the peer communication terminal makes contact with the second index server.

5. The method as claimed in claim 1, wherein
the peer communication terminal sends a second make-contact message, which is addressed to the second index server, following the response message,
the second make-contact message is transmitted to the proxy node, and
the proxy node forwards the second make-contact message to the second index server, as a result of which contact is made between the peer communication terminal and the second index server.
